(19) United States
(12) Patent Application Publication
(10) Pub. No.: US 2025/0271299 A1
(43) Pub. Date: Aug. 28, 2025

(54) LIGHT BRIGHTNESS DETECTION METHOD, ELECTRONIC DEVICE, NON-TRANSITORY COMPUTER READABLE STORAGE MEDIUM, PROCESSOR AND COMPUTER PROGRAM PRODUCT

(71) Applicant: Wuhan Tianma Microelectronics Co., Ltd. Shanghai Branch, Shanghai (CN)

(72) Inventors: Mengying JIANG, Shanghai (CN); Chong QIAN, Shanghai (CN); Nana XIONG, Shanghai (CN); Ning KANG, Shanghai (CN); Shengjuan LIU, Shanghai (CN)

(21) Appl. No.: 19/192,293

(22) Filed: Apr. 28, 2025

(30) Foreign Application Priority Data
Dec. 23, 2024 (CN) 202411917800.X

(51) Int. Cl. G01J 1/44; G01J 1/42

(52) U.S. Cl. CPC G01J 1/44; G01J 1/4204; G01J 2001/446

(57) ABSTRACT

A light brightness detection method, an electronic device, a processor and a computer program product. The method includes: a first detection step of detecting an output electrical signal of a first optical sensor within a first exposure duration; a second detection step of detecting an output electrical signal of a second optical sensor within a second exposure duration; and a determination step of stopping detection when an output electrical signal obtained in any one of the detection steps is within a predetermined electrical signal range. The method solves the problem of low detection accuracy of an ambient light sensor in the related art.

### CROSS-REFERENCE TO RELATED APPLICATIONS

The present application claims priority to Chinese Patent Application No. 202411917800.X, filed on Dec. 23, 2024, the content of which is incorporated herein by reference in its entirety.

### TECHNICAL FIELD

The present disclosure relates to the technical field of display, and in particular, to a light brightness detection method, an electronic device, a non-transitory computer readable storage medium, a processor and a computer program product.

### BACKGROUND

With the continuous updating of electronic devices, an ambient light sensor has become basic assembly. The ambient light sensor (also referred to as optical sensor) mainly uses an optical component to generate photocurrent under illumination to cause changes in the detection potential, and then by determining the illumination intensity according to the potential change values, thereby detecting the intensity of light in an environment where the electronic device is located.

At present, the ambient light sensor is mainly provided below a display screen, but for such a configuration, the sensor is easily affected by light emission on the display screen in a process of detecting the ambient light, thereby reducing the detection accuracy. Meanwhile, due to a wide range of the ambient light brightness, for an optical sensor with a given exposure duration, the low-brightness environment has a small photo-generated current and a weak optical signal; and a high-brightness environment has a problem that the photo-generated current is too large and the optical signal is saturated, resulting in inaccurate detection accuracy of the optical sensor.

Therefore, there is a need to provide a method for improving the detection accuracy of the ambient light sensor.

### SUMMARY

A main object of the present disclosure is to provide a light brightness detection method, an electronic device, a computer readable storage medium, a processor and a computer program product, so as to at least solve the problem of low detection accuracy of an ambient light sensor in the related art.

In an aspect of the present disclosure, provided is a light brightness detection method, including: a first detection step of detecting an output electrical signal of a first optical sensor within a first exposure duration; a second detection step of detecting an output electrical signal of a second optical sensor within a second exposure duration, which is different from the first exposure duration; and a determination step of stopping detection when an output electrical signal obtained in any one of the detection steps is within a predetermined electrical signal range.

In another aspect of the present disclosure, provided is an electric device, including at least one optical sensor, one or more processors, a memory, and one or more programs, wherein the one or more programs are stored in the memory and configured to be executed by the one or more processors, and the one or more programs include instructions for performing a light brightness detection method, including: a first detection step of detecting an output electrical signal of a first optical sensor within a first exposure duration; a second detection step of detecting an output electrical signal of a second optical sensor within a second exposure duration, which is different from the first exposure duration; and a determination step of stopping detection when an output electrical signal obtained in any one of the detection steps is within a predetermined electrical signal range.

In another aspect of the present disclosure, provided is a non-transitory computer-readable storage medium, including a program stored therein, when the program is run, a device where the computer-readable storage medium is arranged is configured to perform a light brightness detection method, including: a first detection step of detecting an output electrical signal of a first optical sensor within a first exposure duration; a second detection step of detecting an output electrical signal of a second optical sensor within a second exposure duration, which is different from the first exposure duration; and a determination step of stopping detection when an output electrical signal obtained in any one of the detection steps is within a predetermined electrical signal range.

In another aspect of the present disclosure, provided is a processor, configured to run a program, when the program is run, a light brightness detection method is performed, and the light brightness detection method includes: a first detection step of detecting an output electrical signal of a first optical sensor within a first exposure duration; a second detection step of detecting an output electrical signal of a second optical sensor within a second exposure duration, which is different from the first exposure duration; and a determination step of stopping detection when an output electrical signal obtained in any one of the detection steps is within a predetermined electrical signal range.

In another aspect of the present disclosure, provided is a computer program product, including a computer program, when the computer program is executed by a processor, steps of a light brightness detection method are performed, and the light brightness detection method includes: a first detection step of detecting an output electrical signal of a first optical sensor within a first exposure duration; a second detection step of detecting an output electrical signal of a second optical sensor within a second exposure duration, which is different from the first exposure duration; and a determination step of stopping detection when an output electrical signal obtained in any one of the detection steps is within a predetermined electrical signal range.

### BRIEF DESCRIPTION OF DRAWINGS

The accompanying drawings, which form a part of the present disclosure, are configured to provide a further illustration of the present disclosure, and the schematic embodiments and descriptions of the present disclosure are configured to explain the present disclosure, and do not constitute an improper limitation on the present disclosure.

FIG. 1 illustrates a hardware structural block diagram of a mobile terminal for performing a light brightness detection method according to an embodiment of the present disclosure;

FIG. 2 is a flowchart diagram of a light brightness detection method according to an embodiment of the present disclosure;

FIG. 3 shows a structural diagram of a light brightness detection circuit using three thin film transistors according to an embodiment of the present disclosure;

FIG. 4 shows a timing diagram of detecting and generating light brightness by using three thin film transistors in a light brightness detection method according to an embodiment of the present disclosure; and

FIG. 5 shows a structural diagram of a light brightness detection circuit using one thin film transistor in a light brightness detection method according to an embodiment of the present disclosure.

### DESCRIPTION OF EMBODIMENTS

It should be noted that the embodiments of the present disclosure and the features in the embodiments may be combined with each other without conflicts. The present disclosure will be further described with reference to the accompanying drawings.

In order to make those skilled in the art better understand the solutions of the present disclosure, technical solutions in embodiments of the present disclosure will be described below in connection with the drawings in the present disclosure. It is appreciated that, the described embodiments are only a part of the embodiments of the present disclosure, not all of them. Based on the embodiments the present disclosure, all other embodiments obtained by those skilled in the art without any creative efforts fall within the protection scope of the present disclosure.

It should be noted that the terms “first”, “second” and the like in the specification, claims and drawings of the present disclosure are configured to distinguish similar objects, and are not necessarily configured to describe a specific order or sequence. It should be understood that the data used in this way may be interchanged under appropriate circumstances, so as to facilitate the embodiments of the present disclosure described herein. Furthermore, the terms “include” and “have” and any variations thereof are intended to cover non-exclusive inclusion, e.g., processes, methods, systems, products or devices that include a series of steps or units are not necessarily limited to those steps or units that are expressly listed, but may include other steps or units not expressly listed or inherent to such processes, methods, products or devices.

As described in the background, the problem of low detection accuracy of ambient light sensors in the related art is addressed, in order to solve the above problems, embodiments of the present disclosure provide a light brightness detection method, an electronic device, a computer readable storage medium, a processor and a computer program product.

The technical solutions in the embodiments of the present disclosure will be described below in combination with the accompanying drawings in the embodiments of the present disclosure.

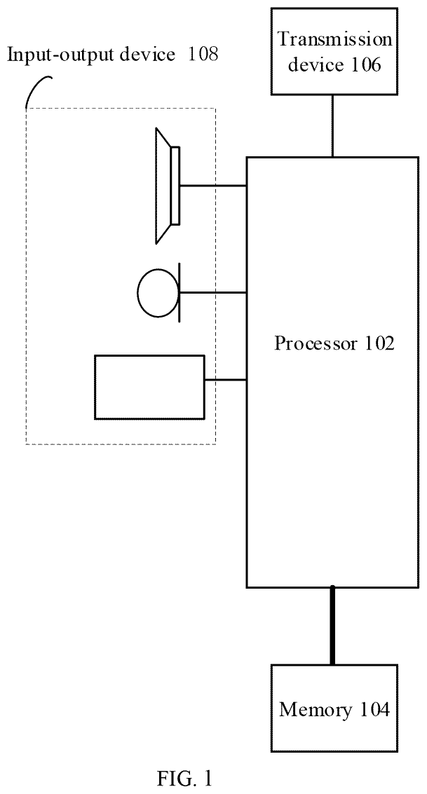

The method embodiments provided in the embodiments of the present disclosure may be performed in a mobile terminal, a computer terminal, or a similar computing device. Taking running on a mobile terminal as an example, FIG. 1 illustrates a hardware structural block diagram of a mobile terminal for performing a light brightness detection method according to an embodiment of the present disclosure, as shown in FIG. 1, the mobile terminal may include one or more (only one is shown in FIG. 1) processors 102 (the processor 102 may include but is not limited to a processing device such as a microprocessor MCU or a programmable logic device FPGA), and a memory 104 for storing data. The mobile terminal may further include a transmission device 106 for a communication function, and an input-output device 108. Those skilled in the art may understand that the structure shown in FIG. 1 is merely an example, and does not limit the structure of the mobile terminal. For example, the mobile terminal may further include more or fewer assemblies than those shown in FIG. 1, or have a configuration different from that shown in FIG. 1.

The memory 104 may be configured to store a computer program, for example, a software program and a module of an application software, such as a computer program corresponding to the device information display method in the embodiments of the present disclosure, and the processor 102 executes various functional applications and data processing by running the computer programs stored in the memory 104, that is, implements the above method. The memory 104 may include a high-speed random access memory, and may further include a non-volatile memory, such as one or more magnetic storage devices, flash memories, or other non-volatile solid-state memories. In some examples, the memory 104 may further include memories remotely provided relative to the processor 102, and these remote memories may be connected to the mobile terminals through a network. Examples of such networks include, but are not limited to, the Internet, an intranet, a local area network, a mobile communication network, and a combination thereof. The transmission device 106 is configured to receive or send data via a network. Specific examples of the network may include a wireless network provided by a communication provider of the mobile terminal. In an example, the transmission device 106 includes a network interface controller (NIC), which may be connected to another network device through a base station, so as to communicate with the Internet. In an example, the transmission device 106 may be a radio frequency (RF) module configured to communicate with the Internet in a wireless manner.

As described in the background, the exposure duration of the optical sensor in the related art is unchanged, and under a condition of relatively strong and weak ambient light brightness, the detection accuracy of the optical detection sensor is poor, and the detected ambient light brightness is inaccurate.

In order to solve the above technical problems of the present disclosure, a light brightness detection method running on a mobile terminal, a computer terminal or a similar computing device is provided in an embodiment of the present disclosure, and it should be noted that the steps shown in the flowchart of the accompanying drawings may be performed in a computer system such as a set of computer-executable instructions, and although a logical order is shown in the flowchart, in some cases, the steps shown or described may be performed in a different order.

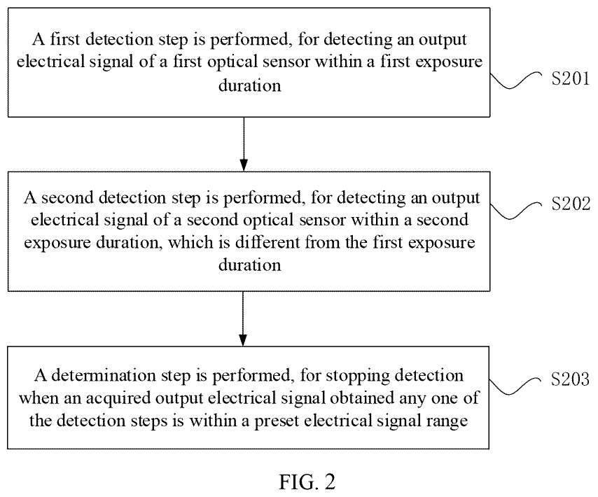

FIG. 2 is a flowchart diagram of a light brightness detection method according to an embodiment of the present disclosure. As shown in FIG. 2, the method includes the following steps.

At step S201, a first detection step is performed, for detecting an output electrical signal of a first optical sensor within a first exposure duration.

The first exposure duration is set, the first optical sensor is controlled to be exposed within the first exposure duration, and the electrical signal output by the first optical sensor after exposure is controlled to be detected.

At step S202, a second detection step is performed, for detecting an output electrical signal of a second optical sensor within a second exposure duration, which is different from the first exposure duration.

The second exposure duration is set, the second optical sensor is controlled to be exposed within the second exposure duration, and the electrical signal output by the second optical sensor after exposure is controlled to be detected.

At step S203, a determination step is performed, for stopping detection when an output electrical signal obtained in any one of the detection steps is within a predetermined electrical signal range.

In an embodiment, by detecting electrical signals output after exposing different optical sensors in different exposure durations, it is determined whether an electrical signal is within a predetermined electrical signal range; and if an electrical signal is within the predetermined electrical signal range, the detection is stopped. This indicates that this exposure duration is suitable for the current ambient light brightness, and the corresponding output electrical signal can be used to accurately determine the ambient light brightness.

In the above embodiments, firstly, the output electrical signal of the first optical sensor is detected within the first exposure duration; secondly, the output electrical signal of the second optical sensor is detected within the second exposure duration, which is different from the first exposure duration; and finally, when the output electrical signal obtained in any one of the detection steps is within the predetermined electrical signal range, the detection is stopped. Compared with the solution that the timing of the optical sensor is set to be the fixed exposure duration in the related art, the solutions of the present disclosure adopt different exposure durations for driving, that is, adopt a variable frequency mode for driving, and determine the ambient light brightness according to the corresponding exposure duration when the tested electrical signal is within the predetermined electrical signal range, thereby solving the problem of low detection accuracy of the ambient light sensor in the related art.

The first optical sensor in the first detection step and the second optical sensor in the second detection step may be the same optical sensor, or may be different optical sensors. In an actual application, different optical sensors may be selected according to an actual situation to perform the two detection steps, or the same optical sensor may be selected to perform the two detection steps.

In an embodiment of the present disclosure, the first optical sensor and the second optical sensor are the same optical sensor. The second detection step includes: detecting an output electrical signal of the second optical sensor within the second exposure duration upon determining that the output electrical signal in the first detection step is not within the predetermined electrical signal range, that is, an accurate electrical signal cannot be detected in the first detection step. The determination step includes: stopping detection when the output electrical signal obtained in the second detection step is within the predetermined electrical signal range. In this method, detection is carried out through one optical sensor: firstly, the optical sensor performs detection within a first exposure duration and outputs an electrical signal to determine whether the electrical signal is within a predetermined range or not; and if it is not within the range, the second detection is performed, and the optical sensor performs detection within the second exposure duration and outputs an electrical signal, and if the output electrical signal is within the predetermined range, the detection will be stopped.

In the solution of detecting the ambient light by using the same optical sensor, the exposure duration is adjusted only when the output electrical signal in the first detection step is not within the predetermined electrical signal range, that is, the second detection step is performed only after the first detection step is performed, so that the detection time is relatively long. In order to make the efficiency of detecting the light brightness higher, in an embodiment of the present disclosure, the first optical sensor and the second optical sensor are different optical sensors, and the first detection step and the second detection step are performed synchronously.

In an actual detection process, when the output electrical signals obtained in the first detection step and the second detection step are both not within the predetermined electrical signal range, the determination step may further include: repeatedly performing the first detection step and/or the second detection step. During the repeated performing process, the exposure duration is increased or decreased until a corresponding output electrical signal is within the predetermined electrical signal range, then the detection is stopped. When the exposure duration (the first exposure duration or the second exposure duration) corresponding to the detection step (the first detection step or the second detection step) is relatively short, in the repeated performing process, the exposure duration is gradually increased until a corresponding output electrical signal is within the predetermined electrical signal range, then the detection is stopped. When the exposure duration (the first exposure duration or the second exposure duration) corresponding to the detection step (the first detection step or the second detection step) is relatively long, in the repeated performing process, the exposure duration is gradually decreased until a corresponding output electrical signal is within the predetermined electrical signal range, then the detection is stopped.

In an actual detection process, when the output electrical signals obtained in the first detection step and the second detection step are both not within the predetermined electrical signal range, the determination step may further include: controlling to perform multiple other detection steps, where the optical sensors in any two other detection steps are not the same, and the exposure durations in any two other detection steps are different from each other and different from the first exposure duration and the second exposure duration. These other detection steps can be performed synchronously to determine the target exposure duration more quickly.

In the foregoing solutions, the first detection step may be separately repeated, or the second detection step may be separately repeated. In a case that the optical sensors in the first detection step and the second detection step are different optical sensors, the first detection step and the second detection step may be repeated simultaneously, and in the repeated process, the duration of the exposure duration is increased, and the duration of the exposure duration is decreased, so that the exposure duration within the predetermined electrical signal range can be found more efficiently, thereby determining the ambient light brightness more efficiently.

In another embodiment, the first detection step and/or the second detection step may include: controlling a detection circuit to reset a voltage of the predetermined optical sensor, and determining that the voltage reset is completed when a reset duration reaches a first predetermined duration; then reading a voltage at a predetermined terminal of the detection circuit to obtain a first voltage, that is, a voltage after the reset; exposing the predetermined optical sensor, and reading a voltage of the predetermined terminal to obtain a second voltage when exposing a predetermined exposure duration, that is, reading a voltage after the exposure, where the first voltage and the second voltage include the voltage of the predetermined optical sensor; calculating a difference between the first voltage and the second voltage to obtain an output electrical signal of the predetermined optical sensor, where the output electrical signal is actually an electrical signal change value of the predetermined optical sensor before and after the exposure, and may be specifically a voltage change value. In the first detection step, the predetermined optical sensor is the first optical sensor, and the predetermined exposure duration is the first exposure duration. In the second detection step, the predetermined optical sensor is the second optical sensor, and the predetermined exposure duration is the second exposure duration. According to the method, the predetermined optical sensor is reset, the voltage change value of the optical sensor in the exposure duration can be more accurately obtained, thereby further ensuring the accuracy of the obtained output electrical signal of the optical sensor, and thus further improving the light brightness detection accuracy of the optical sensor.

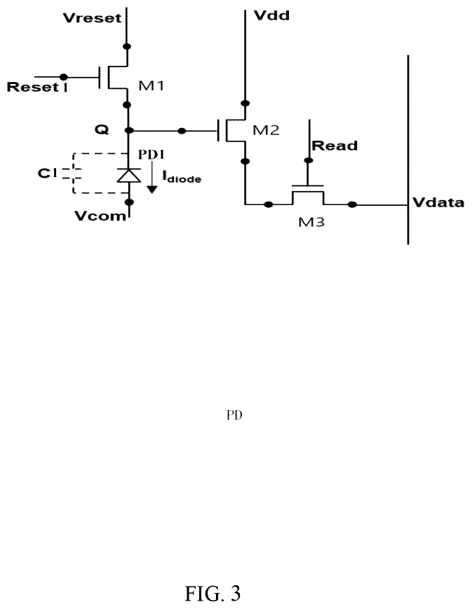

In order to detect the optical signal more accurately and output the corresponding result more accurately, thereby further improving the detection accuracy of the optical sensor, in an embodiment of the present disclosure, each of the first optical sensor and the second optical sensor is a first photodiode PD1, and a photocurrent I_{diode} is generated under illumination, causing a potential of a Q point of the first photodiode PD1 to change, thereby detecting the ambient light brightness. As shown in FIG. 3, the detection circuit includes a first thin film transistor M1, a second thin film transistor M2 and a third thin film transistor M3. A first electrode of the first thin film transistor M1 is electrically connected to a gate of the second thin film transistor M2 and a negative electrode of the first photodiode PD1, a gate of the first thin film transistor M1 is connected to a first reset signal Reset1, a second electrode of the first thin film transistor M1 is connected to a first power supply voltage Vreset, a first electrode of the second thin film transistor M2 is electrically connected to a second electrode of the third thin film transistor M3, a second electrode of the second thin film transistor M2 is connected to a second power supply voltage Vdd, a positive electrode of the first photodiode PD1 is connected to a third power supply voltage Vcom, a gate of the third thin film transistor is connected to a read signal Read, a first electrode of the third thin film transistor is the predetermined terminal of the detection circuit, and a detection voltage thereof is Vdata.

The first photodiode PD1 shown in FIG. 3 is equivalent to a charging and discharging process of a capacitor during the resetting and exposing process, so the first capacitor C1 in FIG. 3 is not actually present in the circuit, but means that the first photodiode PD1 is equivalent to the first capacitor C1.

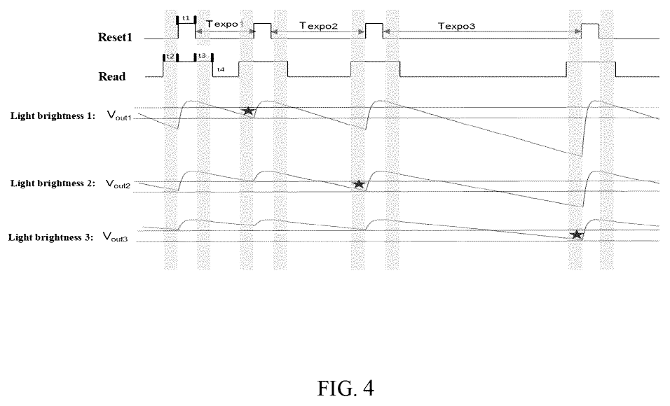

In another embodiment, the process of “controlling a detection circuit to reset a voltage of the predetermined optical sensor, and when a reset duration reaches a first predetermined duration, reading a voltage at a predetermined terminal of the detection circuit to obtain a first voltage; exposing the predetermined optical sensor, and reading a voltage of the predetermined terminal to obtain a second voltage when exposing a predetermined exposure duration, where the first voltage and the second voltage include the voltage of the predetermined optical sensor” may include: as shown in FIGS. 3 and 4, controlling the read signal Read to be at a high level, such that the third thin film transistor is conducted; when the read signal Read is maintained at a high level for a second predetermined duration t2, controlling the first reset signal Reset1 to be at a high level, such that the first thin film transistor M1 and the second thin film transistor M2 are conducted, the potential of the negative electrode of the first photodiode PD1 is reset, that is, the negative electrode of the first photodiode PD1 is loaded with a relatively high voltage, that is, the potential at the Q point is relatively high, the first photodiode PD1 is reversely biased, during the reset process of the first photodiode PD1, changes of the voltage of two terminals of the first photodiode PD1 are similar to the charging process of the capacitor C1; determining that the reset is completed when the first reset signal Reset1 is maintained at a high level for the first predetermined duration t1, reading the first voltage, and controlling the first reset signal Reset1 to be at a low level and starting exposing the first photodiode PD1 simultaneously, in the exposure process, the first photodiode PD1 generates photo-generated carriers, that is, photo-generated electrons and photo-generated holes, and after exposing a certain duration, the potential at the Q point decreases, and in this process, changes of voltages of two terminals of the first photodiode PD1 are similar to the discharging process of the capacitor C1; controlling the read signal Read to be at a low level when the exposure duration reaches a third predetermined duration t3, and controlling the read signal Read to be at a high level when the read signal Read is maintained at the low level for a fourth predetermined duration t4; when the exposure duration reaches the predetermined exposure duration, as shown in FIG. 4, in the first detection step, the predetermined exposure duration is the first exposure duration Texpo1, reading the second voltage, which is the voltage of the first photodiode PD1 after the exposure, and synchronously controlling the first reset signal Reset1 to be at a high level, the predetermined exposure duration t being greater than a sum of the third predetermined duration t3 and the fourth predetermined duration t4, that is, t>t3+t4. In this method, by controlling the levels of the first reset signal Reset1 and the read signal Read, it is further ensured that the voltage of the optical sensor is accurately reset and read, thereby further improving the accuracy and stability of the optical sensor. In addition, by controlling t>t3+t4, the read signal Read can be maintained at a high level for a period of time after exposure, so that Vdata can be read within a period of time after reset or and exposure, which can more truly represent the performance of the device, further ensuring that the obtained voltage of the first photodiode PD1 after reset is more accurate, and then the obtained output electrical signal of the predetermined optical sensor is more accurate, further ensuring the accuracy of subsequent ambient light detection.

In order to further ensure the accuracy of the first voltage obtained after reset, in an embodiment of the present disclosure, t3≤Texpo/10, where Texpo is a predetermined exposure duration, and when the predetermined exposure duration is the first exposure duration, t3≤Texpo1/10. By setting t3 to be within this range, it can be further ensured that within t3, there are few photo-generated carriers after exposure, which has little influence on the voltage of the current first photodiode PD1, thereby further ensuring accurate reading of the reset first voltage.

In a specific implementation process, the first voltage and the second voltage may be voltages read at a time point in the reading phase, for example, the first voltage is Vdata when the exposure duration reaches t3. The first voltage and the second voltage may also be weighted averages of voltages read in the reading phase, and those skilled in the art may select or calculate the corresponding first voltage and second voltage according to actual conditions.

The predetermined exposure duration may be the first exposure duration or the second exposure duration, and when the output electrical signals obtained in the first detection step and the second detection step are not within the predetermined electrical signal range, the determination step may further includes other detection step, and the predetermined exposure duration may also be an exposure duration in other detection step.

In an embodiment, as shown in FIG. 4, when the circuit is driven with a variable frequency, one exposure of the circuit needs two pulse timing sequences. For example, to complete the first exposure (an exposure phase with a corresponding predetermined exposure duration of Texpo1) and read, it needs to mark the first reset signal Reset1 after the first reset and the corresponding read signal Read, and perform continuous exposure according to different exposure durations, for example, a second exposure (an exposure phase with a corresponding predetermined exposure duration of Texpo2) and a third exposure (an exposure phase with a corresponding predetermined exposure duration of Texpo3) in the figure. Light brightness 1, light brightness 2 and light brightness 3 are light brightnesses of different illumination intensities, and which are ordered from high to low as follows: light brightness 1, light brightness 2 and light brightness 3, and Vout potential is Vdata in the circuit of FIG. 3.

In an embodiment, as shown in FIG. 4, under a relatively strong light, that is, light brightness 1, with a first exposure duration Texpo1, the output electrical signal is a first electrical signal Vout1, which is within a rear-end read voltage range (a predetermined electrical signal range), indicating that the current exposure duration matches the ambient light brightness. If the exposure duration increases, that is, with Texpo2, the corresponding output electrical signal is a second electrical signal Vout2, which is not within the predetermined electrical signal range, indicating that the current exposure duration does not match the ambient light brightness. Under a relatively weak light brightness 3, with a first exposure duration Texpo1, the output electrical signal is Vout3, which is not within the predetermined electrical signal range, indicating that the current exposure duration does not match the ambient light brightness, the exposure duration needs to be increased, the exposure duration is prolonged to Texpo3, and the readout electrical signal is within the predetermined electrical signal range, indicating that the external light matches the light corresponding to Texpo3. It should be noted that stars in FIG. 4 indicate that corresponding values are within a predetermined electrical signal range.

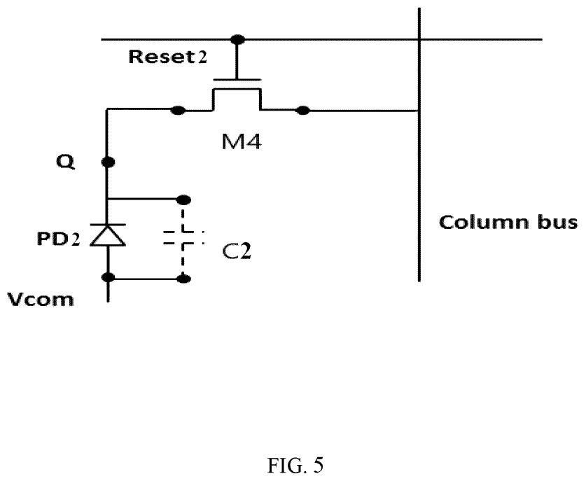

In order to make the structure of the detection circuit simpler, in an embodiment of the present disclosure, as shown in FIG. 5, each of the first optical sensor and the second optical sensor is a second photodiode PD2. The detection circuit includes a fourth thin film transistor M4. A first electrode of the fourth thin film transistor M4 is electrically connected to a negative electrode of the second photodiode PD2. A gate of the fourth thin film transistor M4 is connected to a second reset signal Reset2. A positive electrode of the second photodiode PD2 is connected to a third power supply voltage Vcom. A second electrode of the fourth thin film transistor is connected to a column bus. The second electrode of the fourth thin film transistor M4 is the predetermined terminal of the detection circuit.

The second photodiode PD2 shown in FIG. 5 is equivalent to a charging and discharging process of a capacitor during the resetting and exposing process, therefore, the first capacitor C2 in FIG. 5 is not actually present in the circuit, but means that the second photodiode PD2 is equivalent to the second capacitor C2.

In another embodiment, the process of “controlling a detection circuit to reset a voltage of the predetermined optical sensor, and when a reset duration reaches a first predetermined duration, reading a voltage at a predetermined terminal of the detection circuit to obtain a first voltage; exposing the predetermined optical sensor, and reading a voltage of the predetermined terminal to obtain a second voltage when exposing a predetermined exposure duration, where the first voltage and the second voltage include the voltage of the predetermined optical sensor” may include: controlling the second reset signal Reset2 to be at a high level, and powering up the column bus, such that the fourth thin film transistor M4 is conducted, and the potential at the Q point is substantially equal to the voltage on the column bus, that is, the potential at the negative electrode of the second photodiode PD2 is a high potential, such that the second photodiode PD2 is reverse biased, that is, the potential at the negative electrode of the second photodiode PD2 starts to be reset; determining that the reset is completed when the second reset signal Reset2 is maintained at a high level for the first predetermined duration t1, and reading the first voltage, and controlling the second reset signal Reset2 to be at a low level, powering down the column bus, and controlling the second photodiode PD2 to start to be exposed, such that the second photodiode PD2 generates electron-hole pairs under illumination, and during exposure, the second photodiode PD2 generates photo-generated carriers, that is, photo-generated electrons and photo-generated holes, and after exposing a certain duration, the potential at the Q point decreases; when exposure lasts for the predetermined exposure duration, reading the second voltage, and controlling the second reset signal Reset2 to be at a high level and powering up the column bus. In this method, the output electrical signal can be obtained by controlling the on/off of the fourth transistor and the power-up/power-down of the column bus, thereby making the method simpler and more efficient.

It should be noted that the first photodiode PD1 and the second photodiode PD2 of the present disclosure may be the same photodiode, or may be different photodiodes, and those skilled in the art can choose a suitable photodiode according to the actual situations.

It should be further noted that any one of the first thin film transistor, the second thin film transistor, the third thin film transistor and the fourth thin film transistor of the present disclosure may be any feasible thin film transistor in the related art, and those skilled in the art may select a suitable thin film transistor according to an actual situation. In the embodiments of the present disclosure, the first thin film transistor, the second thin film transistor, the third thin film transistor, and the fourth transistor are selected as N-type thin film transistors as examples, but no limitation is made herein. It should be noted that the first thin film transistor, the second thin film transistor, the third thin film transistor, and the fourth transistor can also be P-type transistors. In an example, the first thin film transistor, the second thin film transistor, the third thin film transistor and the fourth thin film transistor of the present disclosure may independently be selected from any one of an amorphous silicon thin film transistor, a low temperature polysilicon thin film transistor and an organic semiconductor thin film transistor. In addition, for each of the thin film transistor, one of the first electrode and the second electrode is a source electrode, and the other one of the first electrode and the second electrode is a drain electrode.

In order to more accurately determine the light brightness of the current environment, in an embodiment of the present disclosure, the detection method further includes: determining a light brightness range corresponding to a current environment according to a target exposure duration, to obtain a target light brightness range, where the target exposure duration is an exposure duration corresponding to the output electrical signal within the predetermined electrical signal range, that is, the exposure duration matches a certain light brightness range, so a corresponding light brightness range can be determined according to the target exposure duration; and determining a correspondence between the output electrical signal and the light brightness according to the target light brightness range, where actually, the correspondence between the output electrical signal and the light brightness is different within different target light brightness ranges, so the correspondence can be determined more accurately according to the target light brightness range, and the light brightness of the current environment is determined within the target light brightness range according to the target output electrical signal and the correspondence. The target output electrical signal is the output electrical signal within the predetermined electrical signal range.

In an example, please refer to Table 1, which is a correspondence between the target light brightness and the target exposure duration.

TABLE 1

| | Target light brightness | | | | | |
|---|---|---|---|---|---|---|
| | range (lux) | | | | | |
| | 100k-20k | 20k-7k | 7k-2k | 2k-0.5k | 0.5k-0.2k | 0.2k-10 |
| Target | T1 | T2 | T3 | T4 | T5 | T6 |
| exposure | | | | | | |
| duration | | | | | | |

To enable those skilled in the art to more clearly understand the technical solutions of the present disclosure, an implementation process of the light brightness detection method of the present disclosure is described in detail below with reference to the embodiments.

An embodiment relates to a light brightness detection method, including the following steps.

At step 1, a detection circuit is controlled to reset a voltage of a predetermined optical sensor, and a voltage of a predetermined terminal of a detection circuit is read to obtain a first voltage when a reset duration reaches a first predetermined duration.

At step 2, the predetermined optical sensor is exposed, and a voltage of the predetermined terminal is read to obtain a second voltage when exposing a predetermined exposure duration.

At step 3, a difference between the first voltage and the second voltage is calculated to obtain an output electrical signal of the optical sensor. A number of exposure durations is set based on whether the output electrical signal is within the predetermined signal range, and until the output electrical signal is within the predetermined signal range, the detection is stopped.

At step 4, a light brightness range corresponding to a current environment is determined according to a target exposure duration, to obtain a target light brightness range.

At step 5, a correspondence between the output electrical signal and the light brightness is determined according to the target light brightness range, and a light brightness of the current environment within the target light brightness range is determined according to a target output electrical signal and the correspondence.

It should be noted that the steps shown in the flowchart of the accompanying drawings may be performed in a computer system such as a set of computer-executable instructions, and although a logical order is shown in the flowchart, in some cases, the steps shown or described may be performed in a different order.

The processor includes a core, and the core retrieves a corresponding program unit from the memory. One or more cores can be provided, and the problem of low detection accuracy of an ambient light sensor in the related art is solved by adjusting core parameters.

The memory may include a non-transitory memory, a random access memory (RAM), and/or a non-volatile memory in the computer-readable medium, for example, a read-only memory (ROM) or a flash RAM, and the memory includes at least one memory chip.

An embodiment of the present disclosure provides a computer readable storage medium. The computer readable storage medium includes a stored program, and when the program is run, a device on which the computer readable storage medium is located is controlled to perform the light brightness detection method. The method includes the following steps.

At step S201, a first detection step is performed, for detecting an output electrical signal of a first optical sensor within a first exposure duration.

At step S202, a second detection step is performed, for detecting an output electrical signal of a second optical sensor within a second exposure duration, which is different from the first exposure duration.

At step S203, a determination step is performed, for stopping detection when an output electrical signal obtained in any one of the detection steps is within a predetermined electrical signal range.

An embodiment of the present disclosure provides a processor. The processor is configured to run a program, and when the program is run, the light brightness detection method is performed. The method includes the following steps.

At step S201, a first detection step is performed, for detecting an output electrical signal of a first optical sensor within a first exposure duration.

At step S202, a second detection step is performed, for detecting an output electrical signal of a second optical sensor within a second exposure duration, which is different from the first exposure duration.

At step S203, a determination step is performed, for stopping detection when an output electrical signal obtained in any one of the detection steps is within a predetermined electrical signal range.

An embodiment of the present disclosure provides an electronic device, including at least one optical sensor, one or more processors, a memory, and one or more programs. The one or more programs are stored in the memory and configured to be executed by the one or more processors, the one or more programs include instructions for performing the various detection methods described above, and the detection method includes at least the following steps.

At step S201, a first detection step is performed, for detecting an output electrical signal of a first optical sensor within a first exposure duration.

At step S202, a second detection step is performed, for detecting an output electrical signal of a second optical sensor within a second exposure duration, which is different from the first exposure duration. The second optical sensor and the first optical sensor may be the same optical sensor, or may be different optical sensors. When the second optical sensor and the first optical sensor are the same optical sensor, the electronic device may only include one optical sensor; and when the second optical sensor and the first optical sensor are different optical sensors, the electronic device may include multiple optical sensors.

At step S203, a determination step is performed, for stopping detection when an output electrical signal obtained in any one of the detection steps is within a predetermined electrical signal range.

According to the light brightness detection method performed by the electronic device, different exposure durations are adopted for driving the optical sensor to be exposed, that is, a variable frequency mode is adopted for driving the optical sensor to be exposed, and the ambient light brightness is determined according to the corresponding exposure duration when the electrical signal is within the predetermined electrical signal range, thereby solving the problem of low detection accuracy of the ambient light sensor in the related art.

In order to detect the optical signal more accurately and output the corresponding result more accurately, thereby further improving the detection accuracy of the optical sensor, in an embodiment of the present disclosure, each of the first optical sensor and the second optical sensor may be a first photodiode PD1, and the photocurrent is generated under illumination, causing the potential of the Q point of the first photodiode PD1 to change, thereby detecting the ambient light brightness. As shown in FIG. 3, the detection circuit includes a first thin film transistor M1, a second thin film transistor M2 and a third thin film transistor M3. A first electrode of the first thin film transistor M1 is electrically connected to a gate of the second thin film transistor M2 and a negative electrode of the first photodiode PD1. A gate of the first thin film transistor M1 is connected to a first reset signal Reset1. A second electrode of the first thin film transistor M1 is connected to a first power supply voltage Vreset. A first electrode of the second thin film transistor M2 is electrically connected to a second electrode of the third thin film transistor M3. A second electrode of the second thin film transistor M2 is connected to a second power supply voltage Vdd. A positive electrode of the first photodiode PD1 is connected to a third power supply voltage Vcom. A gate of the third thin film transistor is connected to a read signal Read. A first electrode of the third thin film transistor is a voltage read terminal, and a detection voltage thereof is Vdata.

The first photodiode PD1 shown in FIG. 3 is equivalent to a charging and discharging process of a capacitor during the resetting and exposing process, so the first capacitor C1 in FIG. 3 is not actually present in the circuit, but means that the first photodiode PD1 is equivalent to the first capacitor C1.

In another embodiment, in order to make the structure of the detection circuit simpler, in an embodiment of the present disclosure, as shown in FIG. 5, the optical sensor is a second photodiode PD2. The electronic device further includes a detection circuit. The detection circuit includes a fourth thin film transistor M4. A first electrode of the fourth thin film transistor M4 is electrically connected to a negative electrode of the second photodiode PD2. A gate of the fourth thin film transistor M4 is connected to a second reset signal Reset2. A positive electrode of the second photodiode PD2 is connected to a third power supply voltage Vcom. A second electrode of the fourth thin film transistor is connected to a column bus. A second electrode of the fourth thin film transistor is a voltage read terminal. The second reset signal is configured to reset a potential of the negative electrode of the second photodiode PD2, thereby making the structure of the detection circuit in the electronic device to be simpler.

The second photodiode PD2 shown in FIG. 5 is equivalent to a charging and discharging process of a capacitor during the resetting and exposing process, so the first capacitor C2 in FIG. 5 is not actually present in the circuit, but means that the second photodiode PD2 is equivalent to the second capacitor C2.

In another embodiment, at least two optical sensors are provided, including a first optical sensor and a second optical sensor. The target exposure duration can be determined more quickly through two optical sensors, making the efficiency of detecting the ambient light brightness by the electronic device to be higher.

In another embodiment, the electronic device is a display device. The display device often needs to detect the ambient light brightness, so that a display mode can be adjusted according to the ambient light brightness.

The device in the present disclosure may be a server, a PC, a PAD, a mobile phone, or the like.

The present disclosure further provides a computer program product, which, when executed on a data processing device, is adapted to execute a program initialized with at least the following method steps.

At step S201, a first detection step is performed, for detecting an output electrical signal of a first optical sensor within a first exposure duration.

At step S202, a second detection step is performed, for detecting an output electrical signal of a second optical sensor within a second exposure duration, which is different from the first exposure duration.

At step S203, a determination step is performed, for stopping detection when an output electrical signal obtained in any one of the detection steps is within a predetermined electrical signal range.

It should be noted that those skilled in the art should understand that the modules or steps of the present disclosure described above may be implemented by using a general-purpose computing device, and they may be integrated in a single computing device, or distributed in a network formed by a plurality of computing devices, and they may be implemented by using program codes executable by the computing devices, so that they may be stored in a storage device and executed by the computing devices, and in some cases, the steps shown or described may be performed in a different order, or they may be separately formed as various integrated circuit modules, or multiple modules or steps thereof may be formed as a single integrated circuit module. Therefore, the present disclosure is not limited to any particular combination of hardware and software.

Those skilled in the art should understand that embodiments of the present disclosure may be provided as a method, a system, or a computer program product. Accordingly, the present disclosure may take the form of an entirely hardware embodiment, an entirely software embodiment, or an embodiment combining software and hardware. Moreover, the present disclosure may take the form of a computer program product implemented in one or more computer usable storage media (including but not limited to magnetic disk storage, CD-ROM, optical storage, etc.) containing computer usable program codes.

The present disclosure is described with reference to flowchart diagrams and/or block diagrams of methods, devices (systems), and computer program products according to embodiments of the present disclosure. It should be understood that each flow and/or block of the flowcharts and/or block diagrams or combinations thereof can be achieved by computer program instructions. These computer program instructions can be provided to a general purpose computer, a special purpose computer, an embedded processor or other programmable data processing device to produce a machine, so that a device for implementing one or more flows in the flowcharts and/or functions specified by one or more blocks in the block diagrams can be produced with the instructions executed by the computer or other programmable data processing device.

These computer program instructions can also be stored in a computer-readable memory that can guide a computer or other programmable data processing device to operate in a specific manner, so that the instructions stored in the computer readable memory generate manufactured articles including the instruction device which implements one or more flows in the flowcharts and/or the functions specified by one or more blocks in the block diagrams.

These computer program instructions can also be loaded to a computer or other programmable data processing device, so that a series of operation steps are performed on the computer or other programmable device to generate the computer-implemented processing, thus enabling the instructions executed in the computer or other programmable device to provide steps for implementing one or more flows in the flowchart and/or functions specified by one or more blocks in the block diagrams.

In a typical configuration, a computing device includes one or more processors (CPUs), input-output interfaces, network interfaces, and memory.

The memory may include a non-transitory memory, a random access memory (RAM), and/or a non-volatile memory in the computer-readable medium, for example, a read-only memory (ROM) or a flash RAM. The memory is an example of computer-readable medium.

Computer-readable media, including permanent and non-permanent, removable and non-removable media, may be implemented in information storage by any method or technology. The information may be computer-readable instructions, data structures, modules of programs, or other data. Examples of storage media for the computer include, but are not limited to, a phase change memory (PRAM), a static random access memory (SRAM), a dynamic random access memory (DRAM), any other random access memory (RAM), a read-only memory (ROM), an electrically erasable programmable read-only memory (EEPROM), a flash memory or other memory technology, a compact disc read-only memory (CD-ROM), a digital versatile disks (DVD) or other optical storage, magnetic cassettes or other magnetic storage devices, or any other non-transmission medium that can be used to store information that can be accessed by the computing device. As defined herein, the computer-readable media does not include transitory media, such as modulated data signals and carrier waves.

It should also be noted that, terms such as “include”, “comprise” or any other variations thereof are intended to cover a non-exclusive inclusion, thus a process, method, product or device including a series of elements includes not only those elements, but also other elements not explicitly listed, or elements inherent in such the process, method, product or device. Without more limitations, an element defined by the statement “including one” does not preclude the presence of another identical element in a process, method, article, or device that includes the element.

From the above description, it can be seen that the above embodiments of the present disclosure achieve the following technical effects.

In the embodiments described above, firstly, the output electrical signal of the first optical sensor is detected within the first exposure duration. Secondly, the output electrical signal of the second optical sensor is detected within the second exposure duration, which is different from the first exposure duration. Finally, when an output electrical signal obtained in any one of the detection steps is within the predetermined electrical signal range, the detection is stopped. Compared with the solution that the timing of the optical sensor is set to be the fixed exposure duration and cannot be adjusted according to the ambient light brightness in the related art, the solutions of the present disclosure adopt different exposure durations for driving, that is, adopt a variable frequency mode for driving, and determine the ambient light brightness according to the corresponding frequency when the electrical signal is within the predetermined electrical signal range, thereby solving the problem of low detection accuracy of the ambient light sensor in the related art.

For those skilled in the art, the present disclosure is not intended to limit the present disclosure and can be subject to various modifications and changes. Any modification, equivalent replacement, improvement, and the like made within the spirit and principles of the present disclosure shall fall within the protection scope of the present disclosure.

What is claimed is:

1. A light brightness detection method, comprising
a first detection step of detecting an output electrical signal of a first optical sensor within a first exposure duration;
a second detection step of detecting an output electrical signal of a second optical sensor within a second exposure duration, which is different from the first exposure duration; and
a determination step of stopping detection when an output electrical signal obtained in any one of the detection steps is within a predetermined electrical signal range.

2. The light brightness detection method according to claim 1, wherein the first optical sensor and the second optical sensor are a same optical sensor,
the second detection step comprises: detecting the output electrical signal of the second optical sensor within the second exposure duration, upon determining that the output electrical signal obtained in the first detection step is not within the predetermined electrical signal range; and
the determination step comprises: stopping detection when the output electrical signal obtained in the second detection step is within the predetermined electrical signal range.

3. The light brightness detection method according to claim 1, wherein the first optical sensor and the second optical sensor are different optical sensors, and the first detection step and the second detection step are performed synchronously.

4. The light brightness detection method according to claim 1, wherein the first detection step and/or the second detection step comprises:
controlling a detection circuit to reset a voltage of a predetermined optical sensor, reading a voltage of a predetermined terminal of the detection circuit to obtain a first voltage when a reset duration reaches a first predetermined duration, exposing the predetermined optical sensor, and reading a voltage of the predetermined terminal to obtain a second voltage when exposing a predetermined exposure duration; and
calculating a difference between the first voltage and the second voltage to obtain an output electrical signal of the predetermined optical sensor,
wherein in the first detection step, the predetermined optical sensor is the first optical sensor, and the predetermined exposure duration is the first exposure duration; and in the second detection step, the predetermined optical sensor is the second optical sensor, and the predetermined exposure duration is the second exposure duration.

5. The light brightness detection method according to claim 4, wherein each of the first optical sensor and the second optical sensor is a first photodiode; the detection circuit comprises a first thin film transistor, a second thin film transistor and a third thin film transistor; a first electrode of the first thin film transistor is electrically connected to a gate of the second thin film transistor and a negative electrode of the first photodiode, a gate of the first thin film transistor is connected to a first reset signal, a second electrode of the first thin film transistor is connected to a first power supply voltage, a first electrode of the second thin film transistor is electrically connected to a second electrode of the third thin film transistor, a second electrode of the second thin film transistor is connected to a second power supply voltage, a positive electrode of the first photodiode is connected to a third power supply voltage, and a gate of the third thin film transistor is connected to a read signal; and a first electrode of the third thin film transistor is the predetermined terminal of the detection circuit.

6. The light brightness detection method according to claim 5, wherein said controlling a detection circuit to reset a voltage of a predetermined optical sensor, reading a voltage of a predetermined terminal of the detection circuit to obtain a first voltage when a reset duration reaches a first predetermined duration, exposing the predetermined optical sensor, and reading a voltage of the predetermined terminal to obtain a second voltage when exposing a predetermined exposure duration, the first voltage and the second voltage comprising a voltage of the predetermined optical sensor, comprises:
controlling the read signal to be at a high level, such that the third thin film transistor is conducted;
controlling the first reset signal to be at a high level when the read signal is maintained at a high level for a second predetermined duration, such that the first thin film transistor and the second thin film transistor are conducted, to reset a potential of the negative electrode of the first photodiode;
reading the first voltage and controlling the first reset signal to be at a low level and starting to expose the first photodiode, when the first reset signal is maintained at the high level for the first predetermined duration;
controlling the read signal to be at a low level when an exposure duration reaches a third predetermined duration, and controlling the read signal to be at a high level when the read signal is maintained at the low level for a fourth predetermined duration; and
reading the second voltage when an exposure duration reaches the predetermined exposure duration, and synchronously controlling the first reset signal to be at a high level, wherein the predetermined exposure duration is greater than a sum of the third predetermined duration and the fourth predetermined duration.

7. The light brightness detection method according to claim 4, wherein each of the first optical sensor and the second optical sensor is a second photodiode; the detection circuit comprises a fourth thin film transistor; a first electrode of the fourth thin film transistor is electrically connected to a negative electrode of the second photodiode, a gate of the fourth thin film transistor is connected to a second reset signal, a positive electrode of the second photodiode is connected to a third power supply voltage, and a second electrode of the fourth thin film transistor is connected to a column bus; and the second electrode of the fourth thin film transistor is the predetermined terminal of the detection circuit.

8. The light brightness detection method according to claim 7, wherein said controlling a detection circuit to reset a voltage of a predetermined optical sensor, reading a voltage of a predetermined terminal of the detection circuit to obtain a first voltage when a reset duration reaches a first predetermined duration, exposing the predetermined optical sensor, and reading a voltage of the predetermined terminal to obtain a second voltage when exposing a predetermined exposure duration, the first voltage and the second voltage comprising a voltage of the predetermined optical sensor, comprises:
controlling the second reset signal to be at a high level and powering up the column bus, such that the fourth thin film transistor is conducted, to reset a potential of the negative electrode of the second photodiode;
reading the first voltage, controlling the second reset signal to be a low level, powering down the column bus, and controlling the second photodiode to start to be exposed, when the second reset signal is maintained at the high level for the first predetermined duration; and
reading the second voltage and controlling the second reset signal to be at a high level and powering up the column bus, when an exposure duration lasts for the predetermined exposure duration.

9. The light brightness detection method according to claim 1, further comprising:
determining a light brightness range corresponding to a current environment according to a target exposure duration, to obtain a target light brightness range, wherein the target exposure duration is an exposure duration corresponding to the output electrical signal being within the predetermined electrical signal range; and
determining a correspondence between the output electrical signal and the light brightness according to the target light brightness range, and determining a light brightness of the current environment within the target light brightness range according to a target output electrical signal and the correspondence, wherein the target output electrical signal is the output electrical signal within the predetermined electrical signal range.

10. An electronic device, comprising at least one optical sensor, one or more processors, a memory, and one or more programs, wherein the one or more programs are stored in the memory and configured to be executed by the one or more processors, and the one or more programs comprise instructions for performing a light brightness detection method, comprising
a first detection step of detecting an output electrical signal of a first optical sensor within a first exposure duration;
a second detection step of detecting an output electrical signal of a second optical sensor within a second exposure duration, which is different from the first exposure duration; and
a determination step of stopping detection when an output electrical signal obtained in any one of the detection steps is within a predetermined electrical signal range.

11. The electronic device according to claim 10, wherein the at least one optical sensor is a first photodiode; the electronic device further comprises a detection circuit; the detection circuit comprises a first thin film transistor, a second thin film transistor, and a third thin film transistor; a first electrode of the first thin film transistor is electrically connected to a gate of the second thin film transistor and a negative electrode of the first photodiode, a gate of the first thin film transistor is connected to a first reset signal, a second electrode of the first thin film transistor is connected to a first power supply voltage, a first electrode of the second thin film transistor is electrically connected to a second electrode of the third thin film transistor, a second electrode of the second thin film transistor is connected to a second power supply voltage, a positive electrode of the first photodiode is connected to a third power supply voltage, and a gate of the third thin film transistor is connected to a read signal; a first electrode of the third thin film transistor is a voltage read terminal; the first reset signal is configured to reset a potential of the negative electrode of the first photodiode; and the read signal is configured to control on/off of the third thin film transistor.

12. The electronic device according to claim 10, wherein the at least one optical sensor is a second photodiode; the electronic device further comprises a detection circuit; the detection circuit comprises a fourth thin film transistor; a first electrode of the fourth thin film transistor is electrically connected to a negative electrode of the second photodiode, a gate of the fourth thin film transistor is connected to a second reset signal, a positive electrode of the second photodiode is connected to a third power supply voltage, and a second electrode of the fourth thin film transistor is connected to a column bus; a second electrode of the fourth thin film transistor is a voltage read terminal; and the second reset signal is configured to reset a potential of the negative electrode of the second photodiode.

13. The electronic device according to claim 10, wherein the at least one optical sensor comprises two optical sensors, which are a first optical sensor and a second optical sensor.

14. The electronic device according to claim 10, wherein the electronic device is a display device.

15. A non-transitory computer-readable storage medium, comprising a program stored therein, wherein when the program is run, a device where the computer-readable storage medium is arranged is configured to perform a light brightness detection method, comprising
a first detection step of detecting an output electrical signal of a first optical sensor within a first exposure duration;
a second detection step of detecting an output electrical signal of a second optical sensor within a second exposure duration, which is different from the first exposure duration; and
a determination step of stopping detection when an output electrical signal obtained in any one of the detection steps is within a predetermined electrical signal range.

16. A processor, configured to run a program, wherein when the program is run, a light brightness detection method is performed, and the light brightness detection method comprises:
a first detection step of detecting an output electrical signal of a first optical sensor within a first exposure duration;
a second detection step of detecting an output electrical signal of a second optical sensor within a second exposure duration, which is different from the first exposure duration; and
a determination step of stopping detection when an output electrical signal obtained in any one of the detection steps is within a predetermined electrical signal range.

17. A computer program product, comprising a computer program, wherein when the computer program is executed by a processor, steps of a light brightness detection method are performed, and the light brightness detection method comprises:
a first detection step of detecting an output electrical signal of a first optical sensor within a first exposure duration;
a second detection step of detecting an output electrical signal of a second optical sensor within a second exposure duration, which is different from the first exposure duration; and
a determination step of stopping detection when an output electrical signal obtained in any one of the detection steps is within a predetermined electrical signal range.
